(19) United States
(12) Patent Application Publication
(10) Pub. No.: US 2025/0176084 A1
(43) Pub. Date: May 29, 2025

(54) LAMP BOARD CIRCUIT

(71) Applicant: HISENSE VISUAL TECHNOLOGY CO., LTD., Qingdao (CN)

(72) Inventors: Fei HUANG, Qingdao (CN); Ruicong LIU, Qingdao (CN); Baolong WANG, Qingdao (CN)

(21) Appl. No.: 19/037,083

(22) Filed: Jan. 25, 2025

Related U.S. Application Data
(63) Continuation of application No. PCT/CN2023/103394, filed on Jun. 28, 2023.

(30) Foreign Application Priority Data
Sep. 19, 2022 (CN) 202211136666.0

(51) Int. Cl. H05B 45/50; G09G 3/32; H05B 45/37

(52) U.S. Cl. CPC H05B 45/50; H05B 45/37; G09G 3/32; G09G 2300/026; G09G 2330/04

(57) ABSTRACT

Provided in the present disclosure is a lamp board circuit, including a detection power input terminal and a detection power return terminal. The detection power input terminal is connected with a detection power supply; a detection signal input terminal of a control switch device is connected with the detection power return terminal; and a driving power input terminal is connected with a driving power supply, and a driving power output terminal is connected with the driving power terminal. When being plugged, a lamp board interface can form a loop with the detection power supply, thereby completing power supply for LED lamp boards without producing surges.

### CROSS REFERENCES TO RELATED APPLICATIONS

This disclosure is a continuation of International Application No. PCT/CN2023/103394, filed on Jun. 28, 2023, which claims priority to Chinese Patent Application No. 202211136666.0, filed on Sep. 19, 2022, all of which is hereby incorporated by reference in their entirety.

### TECHNICAL FIELD

The present disclosure relates to the technical field of display, and in particular to a light emitting diode (LED) lamp board circuit.

### BACKGROUND

With the rapid development of science and technology, light emitting diode (LED) lamps are popular among people because they are superior to other types of lamps in terms of energy saving, environmental protection, color rendering and response speed.

Usually, an LED display screen includes multiple LED lamp boards, and each lamp board is connected by means of lamp board interfaces. In order to ensure the overall display effect of the display screen, the LED lamp board is usually installed by hot plugging, that is, it is installed under power.

### SUMMARY

This disclosed embodiments provide a lamp board circuit for solving the problem of surge caused by the situation where the driving power terminal can be connected first and the ground interface can be connected later during the hot plugging and unplugging process of LED lamp boards in the prior art.

In a first aspect, some embodiments of the present disclosure provide a lamp board circuit, including: a lamp board interface, a control switch device;

the lamp board interface includes: a detection power input terminal, a detection power return terminal and a driving power terminal; where the detection power input terminal can be located at a first end of the lamp board interface, and the detection power return terminal can be located at a second end of the lamp board interface; the detection power input terminal can be connected with a detection power supply; a detection signal input terminal of the control switch device can be connected with the detection power return terminal, a driving power input terminal of the control switch device can be connected with a driving power supply, and a driving power output terminal of the control switch device can be connected with the driving power terminal; based on that a plug of an LED lamp board is fully plugged in the lamp board interface, a conducting path can be formed between the detection power input terminal and the detection power return terminal, and the detection power return terminal can output a first detection signal; the control switch device can be configured to, in response to the first detection signal, allow a conducting path to be formed between the driving power supply and the driving power terminal.

### BRIEF DESCRIPTION OF FIGURES

FIG. 1 is a schematic diagram of a spliced display device provided by some embodiments of the present disclosure.

FIG. 2 is a schematic diagram of a non-display surface of a lamp board provided by one or more embodiments of the present disclosure.

FIG. 3 is a schematic diagram of a detection circuit provided by one or more embodiments of the present disclosure.

FIG. 4 is a schematic diagram of another detection circuit provided by one or more embodiments of the present disclosure.

FIG. 5 is a schematic diagram of another detection circuit provided by one or more embodiments of the present disclosure.

FIG. 6A is a schematic diagram of another detection circuit provided by one or more embodiments of the present disclosure.

FIG. 6B is a schematic diagram of an OC gate structure provided by one or more embodiments of the present disclosure.

FIG. 7 is a schematic diagram of a detection circuit provided by one or more embodiments of the present disclosure.

FIG. 8 is a schematic diagram of another detection circuit provided by one or more embodiments of the present disclosure.

FIG. 9 is a schematic diagram of a detection circuit provided by one or more embodiments of the present disclosure.

### DETAILED DESCRIPTION

In order to make the purpose, technical solutions and advantages of embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, rather than all of the embodiments. Based on the embodiments disclosed in the present disclosure, all other embodiments made by ordinary skilled persons in the art under the inspiration of the embodiments are within the scope of protection of this disclosure.

The terms “first”, “second”, “third”, “fourth”, etc. (if any) in the specification and claims of the present disclosure and the above-mentioned drawings are used to distinguish similar objects and are not necessarily used to describe a specific order or sequence. It is to be understood that the terms so used are interchangeable under appropriate circumstances such that embodiments of the disclosure described herein are capable of being practiced in sequences other than those illustrated or described herein. In addition, the terms “comprises”, “includes” and any variations thereof, are intended to cover a non-exclusive inclusion. For example, a process, method, system, product, or apparatus that includes a series of steps or elements is not necessarily limited to those steps or elements explicitly listed, but may include other steps or elements not explicitly listed or inherent to such process, method, product, or apparatus.

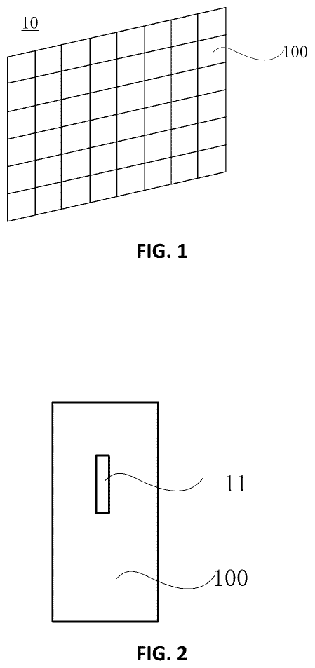

With the rapid development of science and technology and the improvement of people's living standards, the frequency of use of light emitting diode (LED) display screens is increasing. FIG. 1 provides a schematic structural diagram of a spliced display device. Generally, an LED display screen 10 can include a plurality of LED lamp boards 100, and each lamp board can be connected by means of lamp board interfaces and plugs. In order to ensure the overall display effect of the display screen, the LED lamp board can be usually installed by hot plugging, that is, it can be installed under power. The lamp board interface can include a driving power terminal and a ground wire interface. Due to improper operation by the staff, the lamp board interfaces and the driving power terminal of the plug can be connected first, and the lamp board interfaces and the ground wire interface of the plug can be connected later, resulting in surge problems.

During the research on surge protection of LED lamp boards, the inventors found that based on the plug and lamp board interface in the prior art, a surge can occur when the lamp board interface and the driving power terminal of the plug are connected first, and the lamp board interface and the ground interface of the plug are connected later. However, when the lamp board interface and the ground interface of the plug are connected first, and the lamp board interface and the driving power terminal of the plug are connected later, or the driving power terminal and the ground interface of the plug are connected with the lamp board interface at the same time, no surge can occur. That is, after the ground wire interface of the plug and the lamp board interface are connected, no surge can be generated when there is current in the driving power terminal. Therefore, a detection power input terminal and a detection power return terminal can be added to the lamp board interface. The detection power input terminal can be located at the first end of the lamp board interface, and the detection power return terminal can be located at the second end of the lamp board interface. The detection power input terminal can be connected with the detection power supply; the detection signal input terminal of the control switch device can be connected with the detection power return terminal, the driving power input terminal of the control switch device can be connected with the driving power supply, and the driving power output terminal of the control switch device can be connected with the driving power terminal.

Before the plug of the LED lamp board is plugged in the lamp board interface, only the detection power input terminal in the lamp board interface has voltage. When the plug of the LED lamp board is fully plugged in the lamp board interface, that is, when the plug is connected with the driving power terminal and the ground wire interface of the lamp board interface, the detection power input terminal in the lamp board interface can be conductive with the detection power return terminal, so that the detection power return terminal can output a detection signal, and then the detection signal emitted by the detection power can pass through the detection power input terminal and the detection power return terminal in turn to reach the control switch device, and then the driving power supply and the driving power terminal can be conductive by means of the control switch device to complete the power supply of the LED lamp board. At this time, since the ground wire interface is already connected, no surge can be generated. Based on the above inventive concept, a surge protection circuit for the LED lamp board in the present disclosure is designed.

In some embodiments, an LED display screen composed of multiple LED lamp boards is displaying content, but one of the LED lamp boards fails and needs to be replaced with a new LED lamp board. Each LED lamp board has the LED lamp board surge protection circuit disclosed in the present disclosure.

When the LED display screen is displaying content, after the plug of the new LED lamp board is fully plugged in the lamp board interface of the installed LED lamp board, the detection signal emitted by the detection power supply can pass through the detection power supply input terminal and the detection power supply return terminal in the lamp board interface in sequence and reach the control switch device.

The driving power supply and the driving power terminal can be conductive by means of the control switch device to complete the power supply of the new LED lamp board. At this time, since the ground wire interface can be connected, no surge can be generated.

It should be noted that the above scenario is only an example of an application scenario provided by embodiments of the present disclosure. The embodiments of the present disclosure do not limit the actual form of the various devices included in the scenario, nor does it limit the interaction method between the devices. In the application of the solution, it can be set according to actual needs.

The technical solution of the present disclosure is described in detail below through specific embodiments. It should be noted that the following specific embodiments can be combined with each other, and the same or similar concepts or processes cannot be described in detail in some embodiments.

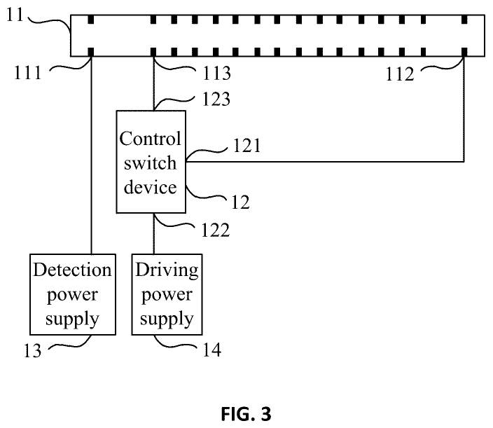

FIG. 2 is a schematic block diagram of a non-display surface of a lamp board provided by one or more embodiments of the present disclosure. The lamp board 100 can be provided with a lamp board interface 11, and the display device can be provided with a corresponding terminal (not shown in the figure). After the lamp board interface 11 is installed, the lamp board can be powered and displayed.

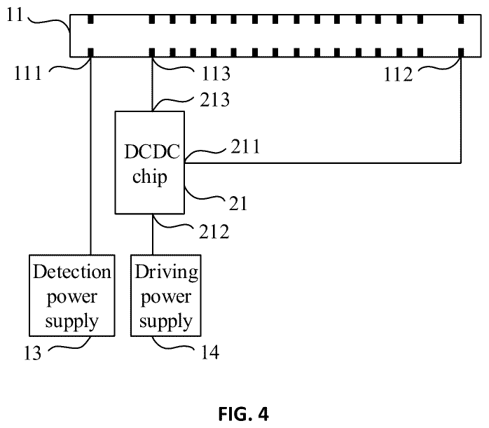

FIG. 3 is a schematic diagram of the structure of an LED lamp board surge protection circuit provided by one or more embodiments of the present disclosure. As shown in FIG. 3, the LED lamp board surge protection circuit can include: a lamp board interface 11 and a control switch device 12.

In some embodiments, the lamp board interface 11 can be disposed on the lamp board, and the detection circuit connected with the lamp board interface 11 can be disposed on the display device side corresponding to the lamp board 100, but the present application does not impose any limitation on this as long as the detection function can be realized.

In some embodiments, the lamp board interface 11 can include a detection power input terminal 111, a detection power return terminal 112 and a driving power terminal 113. The detection power input terminal 111 can be located at the first end of the lamp board interface 11, the detection power return terminal 112 can be located at the second end of the lamp board interface 11, and the detection power input terminal 111 and the detection power return terminal 112 can be located at both ends of the lamp board interface 11, respectively.

The detection power input terminal 111 can be connected with the detection power supply 13 and can be configured to supply power after the lamp board interface 11 is plugged in the terminal of the display device side.

The detection signal input terminal 121 of the control switch device 12 can be connected with the detection power return terminal 112, and can be configured to receive the detection power signal returned by the lamp board interface 11. The driving power input terminal 122 of the control switch device 12 can be connected with the driving power supply 14, and the driving power output terminal 123 of the control switch device 12 can be connected with the driving power terminal 113, and when the signal at the detection signal input terminal 121 is at a high level, the control switch device 12 can be conductive, and the driving power supply 14 can supply power to the LED.

FIG. 3 shows only one driving power terminal. In some embodiments, the number of driving power terminals is at least one. Embodiments of the present disclosure do not limit the number of driving power terminals, which can be determined according to actual conditions.

When the plug of the LED lamp board is fully plugged in the lamp board interface 11, the detection power input terminal 111 and the detection power return terminal 112 can be connected with the detection circuit, so that the first detection signal emitted by the detection power supply 13 can pass through the detection power input terminal 111 and the detection power return terminal 112 in the lamp board interface 11 in sequence and reach the detection signal input terminal 121 of the control switch device 12.

Then, when the control switch device 12 receives the first detection signal through the detection signal input terminal 121, the driving power supply 14 can be conductive with the driving power terminal 113 in the lamp board interface 11 by means of the control switch device 12 to light up the lamp board. At this time, the ground wire interface in the lamp board interface can be connected and no surge can be generated.

It should be noted that the first detection signal can be a high level signal.

When the interface on the side of the lamp board interface 11 is not connected with the detection circuit, the detection circuit cannot form a loop and cannot conduct. At this time, the control switch device cannot conduct, so the lamp board cannot light up to prevent the occurrence of surge phenomenon.

The LED lamp board surge protection circuit provided by the present disclosure can add a detection power input terminal and a detection power return terminal in the lamp board interface, where the detection power input terminal can be located at the first end of the lamp board interface, and the detection power return terminal can be located at the second end of the lamp board interface. Only when the plug of the LED lamp board is fully plugged in the lamp board interface, the detection power input terminal and the detection power return terminal can be conductive, and the detection power return terminal can output the first detection signal. At this time, the plug and the driving power terminal and the ground wire interface in the lamp board interface can be also connected, and then, when the control switch device receives the first detection signal, the driving power supply and the driving power terminal can be conductive by means of the control switch device to power the LED lamp board. Since the plug and the driving power terminal and the ground interface in the lamp board interface are already connected when power is supplied, no surge can be generated, thus achieving surge protection when the LED lamp board is installed with power.

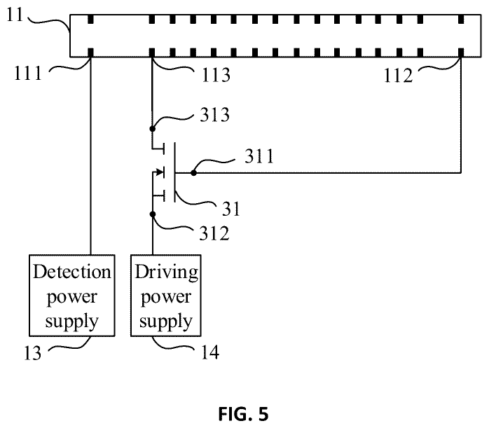

FIG. 4 is a schematic diagram of the structure of a lamp board surge protection circuit provided by some embodiments of the present disclosure, where the control switch device can be a Direct-Current to Direct-Current (DCDC) converting chip.

The enable terminal 211 of the DCDC chip 21 can be connected with the detection power return terminal 112 of the lamp board interface 11, the driving power input terminal 212 of the DCDC chip 21 can be connected with the driving power 14, and the driving power output terminal 213 of the DCDC chip 21 can be connected with the driving power terminal 113 of the lamp board interface 11.

Since only when the level of the enable terminal of the DCDC chip 21 is at a high level, the DCDC chip 21 can work to conduct the driving power supply 14 with the driving power supply interface 113. When the plug of the LED lamp board is fully plugged in the lamp board interface 11, the detection power input terminal 111 can be conductive with the detection power return terminal 112, so that the first detection signal emitted by the detection power 13, that is, the high-level signal, can pass through the detection power input terminal 111 and the detection power return terminal 112 in the lamp board interface 11 in sequence, and reach the enable terminal 211 of the DCDC chip 21.

Furthermore, when the DCDC chip 21 receives a high level signal through the enable terminal 211, the driving power supply 14 and the driving power terminal 113 in the lamp board interface 11 can be conductive by means of the DCDC chip 21. At this time, the ground wire interface in the lamp board interface can be connected and no surge can be generated. When the plug of the LED lamp board is fully plugged in the lamp board interface, the detection power input terminal can be conductive with the detection power return terminal, and the detection power return terminal can output a high-level signal. At this time, the plug can be connected with the driving power terminal and the ground interface in the lamp board interface. Then, when the DCDC chip receives a high-level signal through the enable terminal, the driving power can be conductive with the driving power terminal to power the LED lamp board. Since the plug can be connected with the driving power terminal and the ground interface in the lamp board interface when power is supplied, no surge can be generated, thus achieving surge protection when the LED lamp board is installed with power.

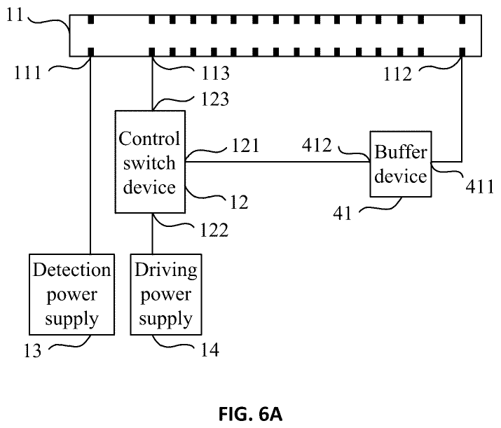

FIG. 5 is a schematic diagram of the structure of an LED lamp board surge protection circuit provided by some embodiments of the present disclosure, where the control switch device can be a metal-oxide semiconductor field-effect transistor (MOS transistor).

As shown in FIG. 5, the surge protection circuit of the LED lamp board can include: a MOS transistor 31.

The gate electrode 311 of the MOS transistor 31 can be connected with the detection power return terminal 122 of the lamp board interface 11, the source electrode 312 of the MOS transistor 31 can be connected with the driving power 14, and the drain electrode 313 of the MOS transistor 31 can be connected with the driving power terminal 113 of the lamp board interface 11.

It should be noted that the MOS transistor can be an N-channel MOS transistor.

When the level of the gate electrode 311 of the MOS transistor 31 is high level, the source electrode 312 and the drain electrode 313 of the MOS transistor 31 can be conductive, so that the driving power supply 14 can be conductive with the driving power supply interface 113. When the plug of the LED lamp board is fully plugged in the lamp board interface 11, the detection power input terminal 111 can be conductive with the detection power return terminal 112, so that the first detection signal emitted by the detection power 13, that is, the high-level signal, can pass through the detection power input terminal 111 and the detection power return terminal 112 in the lamp board interface 11 in sequence, and reach the gate electrode 311 of the MOS transistor 31.

Then, when the MOS transistor 31 receives a high-level signal through the gate electrode 311, the driving power supply 14 can be conductive with the driving power terminal 113 in the lamp board interface 11 by means of the MOS transistor 31. At this time, the ground wire interface in the lamp board interface can be connected and no surge can be generated.

In the LED lamp board surge protection circuit provided by the embodiments, when the plug of the LED lamp board is fully plugged in the lamp board interface, the detection power input terminal can be conductive with the detection power return terminal, and the detection power return terminal can output a high-level signal. At this time, the plug can be connected with the driving power terminal and the ground wire interface in the lamp board interface. Then, when the MOS transistor can receive a high-level signal through the gate electrode, the driving power can be conductive with the driving power terminal to supply power to the LED lamp board. Since the plug can be connected with the driving power terminal and the ground interface in the lamp board interface when power is supplied, no surge can be generated, thus achieving surge protection when the LED lamp board is installed with power.

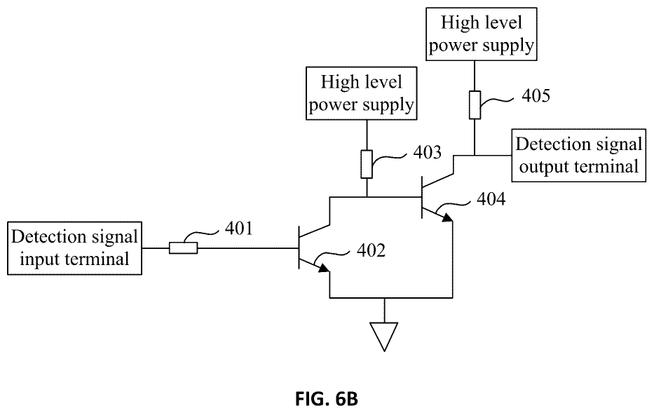

FIG. 6A is a schematic diagram of the structure of a lamp board surge protection circuit provided by some embodiments of the present disclosure. Referring to FIG. 6A, the lamp board surge protection circuit can further include: a buffer device.

The detection signal input terminal 411 of the buffer device 41 can be connected with the detection power return terminal 112, and the detection signal output terminal 412 of the buffer device 41 can be connected with the detection signal input terminal 121 of the control switch device 12.

Since the first detection signal is a high-level signal, the first detection signal can directly reach the detection signal input terminal 121 of the control switch device 12 from the detection power return terminal 112, which can cause damage to the control switch device 12, or the first detection signal can contain an interference signal, causing the control switch device 12 to be interfered. Therefore, a buffer device 41 can be added between the detection power return terminal 112 of the lamp board interface 11 and the detection signal input terminal 121 of the control switch device 12.

After the detection signal input terminal 411 of the buffer device 41 receives the first detection signal, a second detection signal can be obtained through buffering and filtering. The second detection signal is the buffered first detection signal and can still be a high level signal. Then, the second detection signal can be output to the detection signal input terminal 121 of the control switch device 12 through the detection signal output terminal 412 of the buffer device 41. When the detection signal input terminal 121 of the control switch device 12 receives the second detection signal, that is, receives a high level signal, the driving power supply 14 can be conductive with the driving power supply interface 113 of the lamp board interface 11.

In some embodiments, the buffer device 41 can be an open collector (OC) gate.

FIG. 6B is a schematic diagram of an OC gate structure provided by some embodiments of the present disclosure. As shown in FIG. 6B, a first end of the first resistor 401 can be connected with the detection signal input terminal, and a second end of the first resistor 401 can be connected with the base of the first transistor 402. A first end of the second resistor 403 can be connected with a high-level power supply, and a second end of the second resistor 403 can be connected with a collector of the first transistor 402 and a base of the second transistor 404, respectively. A first end of the third resistor 405 can be connected with the high-level power supply, and a second end of the third resistor 405 can be connected with the collector of the second transistor 404 and the detection signal output terminal, respectively. The emitter of the first transistor 402 and the emitter of the second transistor 404 can be grounded. The detection signal input terminal of the OC gate can be connected with the detection power return terminal 112 of the lamp board interface 11, and the detection signal output terminal of the OC gate can be connected with the detection signal input terminal 121 of the control switch device 12.

When the detection signal input terminal is loaded with a high level signal, the high level signal can reach the base of the first transistor 402. Since the base of the first transistor 402 is loaded with a high level signal, the emitter and collector of the first transistor 402 can be turned off, and the base of the second transistor 404 can be loaded with a high level, thereby the emitter and collector of the second transistor 404 can be turned off, and the detection signal output terminal can output a high level signal.

In some embodiments, the buffer device 41 can be an edge detection circuit, the detection signal input terminal of the edge detection circuit can be connected with the detection power return terminal 112 of the lamp board interface 11, and the detection signal output terminal of the edge detection circuit can be connected with the detection signal input terminal 121 of the control switch device 12. The buffer device 41 can also be a hot plug detection circuit, etc. The embodiments of the present disclosure do not limit the buffer device and can be set according to actual conditions.

The lamp board surge protection circuit provided by some embodiments of the present disclosure effectively improves the circuit safety, anti-interference capability and anti-damage capability by adding a buffer device between the detection power return terminal of the lamp board interface and the detection signal input terminal of the control switch device.

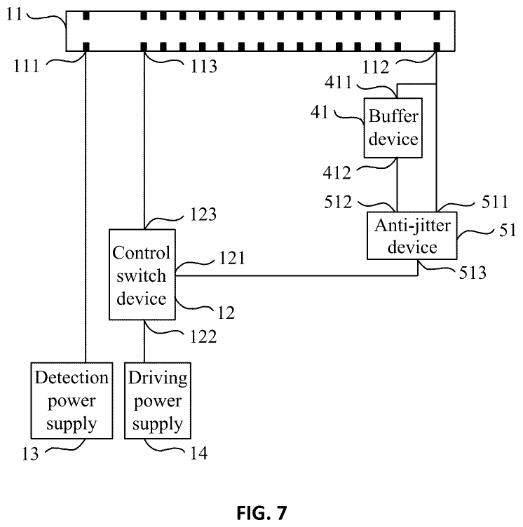

FIG. 7 is a schematic diagram of the structure of a lamp board surge protection circuit provided by some embodiments of the present disclosure, where the lamp board surge protection circuit can include an anti-jitter device.

As shown in FIG. 7, the lamp board surge protection circuit can include an anti-jitter device 51.

The first detection signal input terminal 511 of the anti-jitter device 51 can be connected with the detection power return terminal 112 of the lamp board interface 11; the second detection signal input terminal 512 of the anti-jitter device 51 can be connected with the detection signal output terminal 412 of the buffer device 41; the detection signal output terminal 513 of the anti-jitter device 51 can be connected with the detection signal input terminal 121 of the control switch device 12.

Due to the occurrence of shaking when the plug of the LED lamp board is connected with the lamp board interface 11, the first detection signal output from the detection power return terminal of the lamp board interface 11 can become unstable; and an anti-jitter device 51 can be added. The anti-jitter device 51 can be configured to output a third detection signal 621 when both the first detection signal and the second detection signal are received. That is, when the first detection signal and the second detection signal are both stable, the third detection signal can be output, and the third detection signal can still be a high level signal.

Furthermore, when the control switch device 12 receives the third detection signal, the driving power supply 14 can be conductive with the driving power terminal 113 of the lamp board interface 11 by means of the control switch device 12.

In some embodiments, the anti-jitter device can be an AND gate, and the first detection signal input terminal of the AND gate can be connected with the detection power return terminal 112 of the lamp board interface 11; the second detection signal input terminal of the AND gate can be connected with the detection signal output terminal 412 of the buffer device 41; and the detection signal output terminal of the AND gate can be connected with the detection signal input terminal 121 of the control switch device 12.

In some embodiments, the anti-jitter device is a microcontroller device (MCU), the first detection signal input terminal of the MCU can be connected with the detection power return terminal 112 of the lamp board interface 11; the second detection signal input terminal of the MCU can be connected with the detection signal output terminal 412 of the buffer device 41; the detection signal output terminal of the MCU can be connected with the detection signal input terminal 121 of the control switch device 12.

In some embodiments, the anti-jitter device can be an anti-jitter detection circuit. The embodiments of the present disclosure do not limit the anti-jitter device and can be set according to actual conditions.

The LED lamp board surge protection circuit provided by some embodiments of the present disclosure can increase the anti-jitter capability of the circuit by adding an anti-jitter device connected with the buffer device and the detection power return terminal, so that the third detection signal can be output only when the first detection signal and the second detection signal are stable.

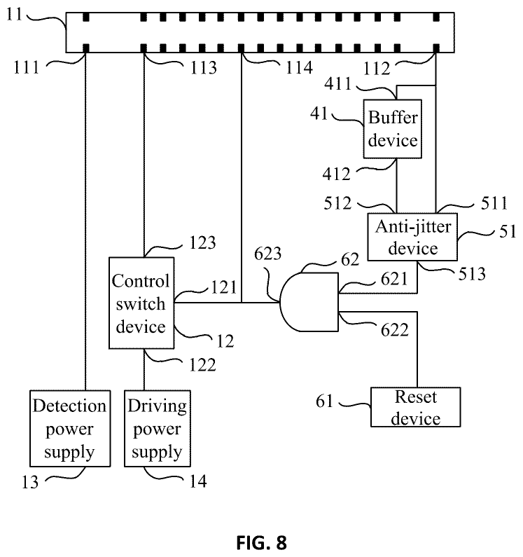

FIG. 8 is a schematic diagram of the structure of a lamp board surge protection circuit provided by some embodiments of the present disclosure. The lamp board surge protection circuit can include: a reset device and an AND gate.

As shown in FIG. 8, the lamp board surge protection circuit can include: a reset device 61 and an AND gate 62; and the lamp board interface 11 can include a driver terminal 114.

The detection signal input terminal 621 of the AND gate 62 can be connected with the detection signal output terminal 513 of the anti-jitter device 51, the reset signal input terminal 622 of the AND gate 62 can be connected with the reset device 61, and the signal output terminal 623 of the AND gate 62 can be respectively connected with the detection signal input terminal 121 of the control switch device 12 and the driver terminal 114 of the lamp board interface 11.

If the LED lamp board first receives the reset signal generated by the reset device, and then the driving power supply 14 can be conductive with the driving power terminal 113 of the lamp board interface 11, so that the LED lamp board can be powered, it can cause the LED display screen to have abnormal images, so the AND gate 62 can be added.

The AND gate 62 can be configured to output the reset signal and the third detection signal at the same time when the AND gate 62 receives both the reset signal output by the reset device 61 and the third detection signal. When the AND gate 62 only receives the third detection signal or only receives the reset signal, the AND gate 62 cannot output any signal. Only when the AND gate 62 receives both the third detection signal and the reset signal, that is, when the third detection signal and the reset signal are both stable, the AND gate 62 can output the reset signal and the third detection signal. When the control switch device 12 receives the third detection signal, the driving power supply 14 and the driving power terminal 113 of the lamp board interface 11 can be conductive. At the same time, the reset signal can reach the driver in the LED lamp board through the driver terminal 114 of the lamp board interface 11. In this way, after the driver is reset successfully, the driver can be synchronized with the controller without causing any abnormal image display.

Some embodiments of the present disclosure provide an LED lamp board surge protection circuit, which can add an AND gate to connect the anti-jitter device and the reset device. When the LED lamp board is powered, the driver can be reset, reducing the occurrence of abnormal image display.

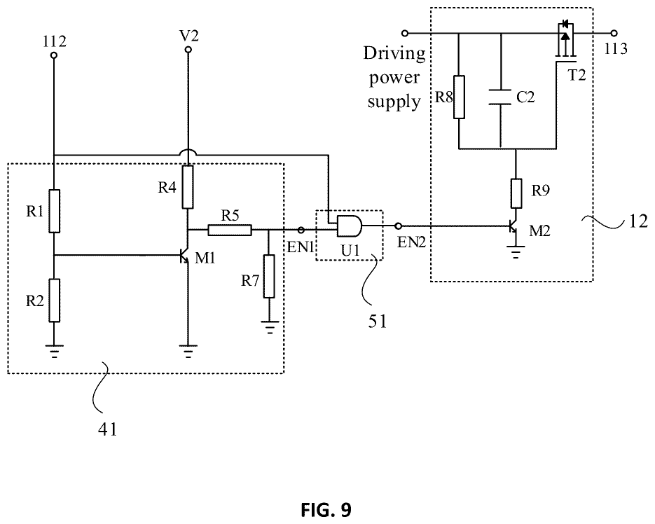

FIG. 9 is a schematic diagram of a detection circuit provided by one or more embodiments of the present disclosure.

As shown in FIG. 9, the detection circuit can include a buffer device 41, an anti-jitter device 51 and a control switch device 12.

The buffer device 41 can include resistors R1, R2, R4, R5, R7, and a transistor M1.

The anti-jitter device 51 can be an AND gate U1.

The control switch device 12 can include a voltage-dividing resistor R8, a charging capacitor C2, a switch field effect transistor T2, a voltage-dividing resistor R9 and a transistor M2.

After the lamp board interface is fully inserted, the voltage of node 112 can be at a high level. The voltage V2 can be a pull-up and pull-down voltage, which can remain at a high level. The resistors R1 and R2 can be voltage-dividing resistors, and the resistors R4, R5, and R7 can adjust the voltage value of the node EN1. After the lamp board interface is inserted, the node 112 can be at a high level, the transistor M1 can be turned on, and the voltage of the EN1 node can be at a high level.

When EN1 and V1 are both high level voltage, the AND gate U1 can be turned on, the voltage of EN2 node can be a high level, the transistor M2 can be turned on, field effect transistor T2 can be turned on, so that the driving power supply voltage can be transmitted to P2 to power the LED on the lamp board.

FIG. 9 is only a schematic diagram of a detection circuit provided by some embodiments of the present disclosure, and the present disclosure is not limited thereto, as long as the purpose of the present disclosure can be achieved.

In some embodiments, the detection circuits can be multiple, and the multiple detection circuits can be connected with different driving power terminals to drive the lamp board, which is not limited in the present disclosure.

Finally, it should be noted that the above embodiments are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or replace some or all of the technical features therein by equivalents. However, these modifications or replacements do not cause the essence of the corresponding technical solutions to deviate from the scope of the technical solutions of the embodiments of the present disclosure.

What is claimed is:

1. A lamp board circuit, comprising: a lamp board interface and a control switch device; wherein:
the lamp board interface comprises: a detection power input terminal, a detection power return terminal and a driving power terminal; wherein the detection power input terminal is at a first end of the lamp board interface, and the detection power return terminal is at a second end of the lamp board interface;
the detection power input terminal is connected with a detection power supply;
a detection signal input terminal of the control switch device is connected with the detection power return terminal, a driving power input terminal of the control switch device is connected with a driving power supply, and a driving power output terminal of the control switch device is connected with the driving power terminal;
based on that a plug of an LED lamp board is fully plugged in the lamp board interface, a conducting path is formed between the detection power input terminal and the detection power return terminal, and the detection power return terminal outputs a first detection signal;
the control switch device is configured to, in response to the first detection signal, allow a conducting path to be formed between the driving power supply and the driving power terminal.

2. The circuit according to claim 1, wherein the control switch device is a Direct-Current to Direct-Current (DCDC) converting chip;
an enable terminal of the DCDC converting chip is connected with the detection power return terminal, a driving power input terminal of the DCDC converting chip is connected with the driving power supply, and a driving power output terminal of the DCDC converting chip is connected with the driving power terminal.

3. The circuit according to claim 1, wherein the control switch device is a metal-oxide semiconductor (MOS) field effect transistor;
a gate electrode of the MOS field effect transistor is connected with the detection power return terminal, a source electrode of the MOS field effect transistor is connected with the driving power supply, and a drain electrode of the MOS field effect transistor is connected with the driving power terminal.

4. The circuit according to claim 1, further comprising: a buffer device;
wherein:
a detection signal input terminal of the buffer device is connected with the detection power return terminal, and the detection signal output terminal of the buffer device is connected with the detection signal input terminal of the control switch device;
the buffer device is configured to output a second detection signal based on the first detection signal;
the control switch device is configured to, in response to the second detection signal, allow the conducting path to be formed between the driving power supply and the driving power terminal.

5. The circuit according to claim 4, further comprising: an anti-jitter device;
a first detection signal input terminal of the anti-jitter device is connected with the detection power return terminal;
a second detection signal input terminal of the anti-jitter device is connected with the detection signal output terminal of the buffer device;
a detection signal output terminal of the anti-jitter device is connected with the detection signal input terminal of the control switch device;
the anti-jitter device is configured to, in response to both the first detection signal and the second detection signal, output a third detection signal;
the control switch device is configured to, in response to the third detection signal, allow the conducting path to be formed between the driving power supply and the driving power terminal.

6. The circuit according to claim 4, wherein the buffer device is an open collector (OC) gate;
a detection signal input terminal of the OC gate is connected with the detection power return terminal, and a detection signal output terminal of the OC gate is connected with the detection signal input terminal of the control switch device.

7. The circuit according to claim 4, wherein the buffer device is an edge detection circuit;
a detection signal input terminal of the edge detection circuit is connected with the detection power return terminal, and a detection signal output terminal of the edge detection circuit is connected with the detection signal input terminal of the control switch device.

8. The circuit according to claim 5, wherein the anti-jitter device is an AND gate;
a first detection signal input terminal of the AND gate is connected with the detection power return terminal;
a second detection signal input terminal of the AND gate is connected with the detection signal output terminal of the buffer device;
a detection signal output terminal of the AND gate is connected with the detection signal input terminal of the control switch device.

9. The circuit according to claim 5, wherein the anti-jitter device is a micro control device (MCU);
a first detection signal input terminal of the MCU is connected with the detection power return terminal;
a second detection signal input terminal of the MCU is connected with the detection signal output terminal of the buffer device;
a detection signal output terminal of the MCU is connected with the detection signal input terminal of the control switch device.

10. The circuit according to claim 5, further comprising: a reset device and an AND gate; wherein the lamp board interface further comprises a driver terminal;
a detection signal input terminal of the AND gate is connected with the detection signal output terminal of the anti-jitter device, a reset signal input terminal of the AND gate is connected with the reset device, and a signal output terminal of the AND gate is connected with the detection signal input terminal of the control switch device and the driver terminal respectively;
the AND gate is configured to, in response to both a reset signal output from the reset device and the third detection signal, simultaneously output the reset signal and the third detection signal.
